(19) United States
(12) Patent Application Publication
(10) Pub. No.: US 2010/0119736 A1
(43) Pub. Date: May 13, 2010

(54) AMBIENT PRESSURE SYNTHESIS OF ZEOLITE FILMS AND THEIR APPLICATION AS CORROSION RESISTANT COATINGS

(75) Inventors: Yushan Yan, Riverside, CA (US); Rui Cai, Pasadena, CA (US); Minwei Sun, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the University of California, Oakland, CA (US)

(21) Appl. No.: 12/575,433

(22) Filed: Oct. 7, 2009

Related U.S. Application Data
(60) Provisional application No. 61/103,448, filed on Oct. 7, 2008.

(51) Int. Cl. C01B 39/02; C01B 39/54; C01B 39/04; B05D 1/36; B05D 3/10; B05D 1/18; B05D 3/06; B05D 3/12; B05D 3/02

(52) U.S. Cl. 427/595; 423/700; 423/704; 423/701; 427/419.7; 427/299; 427/430.1; 427/337; 427/240; 427/372.2; 977/700

(57) ABSTRACT

A method for producing zeolite films or membranes at essentially ambient pressure, which includes preparing a synthesis mixture comprising an ionic liquid solvent and an aluminum and/or silicon and/or phosphate source and converting the synthesis mixture to form a continuous zeolite layer. In addition, a method of synthesizing zeolite nanocrystals, which includes preparing a synthesis mixture, the synthesis mixture having a silica or a silica and alumina source, and a template; and synthesizing the synthesis mixture to form zeolite nanocrystals.

### CROSS-REFERENCES TO RELATED APPLICATIONS

This application claims priority to U.S. Provisional Patent Application No. 61/103,448 filed Oct. 7, 2008, which application is incorporated herein by reference in its entirety and for all purposes.

### STATEMENT AS TO RIGHTS TO INVENTIONS MADE UNDER FEDERALLY SPONSORED RESEARCH OR DEVELOPMENT

This invention was made with Government support under Grant No. DACA72-03-C-0007, awarded by the Department of Defense. The Government has certain rights to this invention.

### BACKGROUND OF THE INVENTION

Metal corrosion is a widespread problem throughout the industrialized world, causing losses amounting to several percent of the gross domestic product of the typical industrialized country. Many types of metals are susceptible to corrosion, with aluminum alloys being prominent examples. The protection of metals against corrosion is generally achieved by applying a coating to the exposed surface of the metal to serve as a physical barrier between the metal and the environment. Organic and inorganic coatings have been used, as well as coatings of metals that are themselves non-corrosive.

Inorganic coatings and certain metal coatings such as electroplated hard chrome generally offer the highest wear resistance besides excellent corrosion resistance. The typical inorganic coatings are chemical conversion coatings, glass linings, enamels and cement. Chemical conversion coatings are produced by intentionally corroding the metal surface in a controlled manner to produce an adherent corrosion product that protects the metal from further corrosion. Examples are anodization, phosphatization, and chromatization.

For example, hexavalent chromium compounds, mainly chromates, have been most widely used as an excellent corrosion inhibitor to protect the very corrodible high strength AI alloys used in aerospace and defense applications, and also for other materials in a wide range of applications. Unfortunately, chromate has become more and more stringently regulated since it is highly toxic and carcinogenic. Hence, a chromium-free alternative with equivalent or superior corrosion performance is critically needed.

### BRIEF SUMMARY OF THE INVENTION

In accordance with an exemplary embodiment, a method for producing zeolite films or membranes at ambient pressure (i.e. about 1 atm), comprises: preparing a synthesis mixture comprising an ionic liquid solvent and aluminum, and/or silicon and/or phosphate source; and convert the synthesis mixture to form a continuous zeolite layer on a substrate. In another embodiment, the method includes converting zeolites formed in situ in an ionic liquid under conditions sufficient to form a continuous zeolite layer, such as zeolite films or membranes on a substrate. In certain instances, the method includes crystallizing zeolites formed in situ in an ionic liquid under conditions sufficient to form a continuous zeolite layer on a substrate.

In accordance with another exemplary embodiment, a method for producing zeolite films or membranes at ambient pressure, comprises; preparing a synthesis mixture comprising an ionic liquid solvent and aluminum, and/or silicon, and/or phosphate sources; stirring the synthesis mixture, for example, at an elevated temperature; introducing a substrate; and heating the synthesis mixture and the substrate under conditions sufficient to form a continuous zeolite layer. In certain instances, the synthesis mixture can be stirred for approximately 4 hours (approximately 240 minutes) at 100 ° C. For example, the stirring requires at least 10 min at a temperature of less than 100° C. Exemplary temperature ranges include 80-100° C., 60-100° C., 40-80° C. and 60-80° C. In other instances, the synthesis mixture and the substrate can be heated to approximately 150° C. to form a continuous zeolite layer. In yet other instances, the synthesis mixture and the substrate can be heated for several hours to several days at a temperature from about 100 to 230° C. to form a continuous zeolite layer. Microwave heating can also be applied to this method of synthesizing zeolite films or membranes to accelerate the synthesis process. Surprisingly, the synthesis time can be drastically shortened by microwave heating. For example, in the presence of microwave heating, the synthesis time is from about 5 min to several hours, such as 2, 3, 4 or 5 hours.

In accordance with a further exemplary embodiment, a method of synthesizing zeolite nanocrystals, comprises: preparing a synthesis mixture and converting the synthesis mixture to form zeolite nanocrystals.

In accordance with another exemplary embodiment, a method of synthesizing zeolite nanocrystals, comprises: preparing a synthesis mixture, the synthesis mixture having a silica or a silica and alumina source, and a template; and synthesizing the synthesis mixture to form zeolite nanocrystals.

In accordance with another exemplary embodiment, a method of synthesizing corrosion resistant silane-zeolite nanocrystal coating, comprises: preparing a silane solution; adding a MEL suspension to the solution to form a nanoparticle-silane mixture; spin coating or dip coating the nanozeolite-silane mixture on a SAPO-11 coated sample; and drying the sample by heating, followed by heating the synthesis mixture under conditions sufficient to form corrosion resistant silane-zeolite nanocrystal coating. In certain instances, the sample can be dried by heating at 80° C. for at least 2 hours, and then heating the synthesis mixture at approximately 120° C. to 200° C. For example, the synthesis mixture can be heated at about 200° C. for at least 5 min (minutes). In other instances, the sample can be kept at room temperature for several hours.

### BRIEF DESCRIPTION OF THE DRAWINGS

FIG. 1 shows a chart comparing particle size and yield versus evaporation weight/total weight for an evaporation-assisted two-stage synthesis method in accordance with an exemplary embodiment.

FIGS. 2(a)-2(c) show dynamic light scattering (DLS) data of the nanoparticle suspensions from the evaporation-assisted two-stage synthesis, wherein (a) number-weighted particle size distribution of MEL E-0, (b) intensity-weighted particle size distribution of E-60, and (c) number-weighted particle size distribution of E-60.

FIGS. 3(a) and 3(b) show TEM images of MEL E-60 nanoparticles with scale bars of: (a) 100 nm and (b) 20 nm.

FIGS. 4(a) and 4(b) show XRD (X-ray diffraction) patterns for the evaporation-assisted two-stage synthesis method in accordance with an embodiment, and crystal sizes calculated from XRD patterns.

FIG. 5 shows pH value and viscosity (with error bars) of the solution with respect to evaporation weight amount.

FIGS. 6(a) and 6(b) show the optical microscopy images of the spin-on films, (a) MEL E-0 calcined film and (b) MEL E-60 calcined film.

FIG. 7 shows XRD (X-ray diffraction) patterns of AEL coatings on a substrate for AIPO-11 and SAPO-11, respectively.

FIGS. 8(a)-8(f) show SEM (scanning electron microscope) images of different as-synthesized AEL coatings on a substrate for AIPO-11, SAPO-11 and SAPO-11 with spin-on BTSM-MEL.

FIGS. 9(a)-9(e) show DC polarization curves for bare and coated substrates in 0.1mol/L NaCl at room temperature for a bare substrate, an AIPO-11 coated substrate; a SAPO-11 coated substrate; SAPO-11 with spin-on BTSM-MEL coated; and spin-on BTSM-MEL coated, respectively.

### DETAILED DESCRIPTION OF THE INVENTION

Using the three-letter code of the International Zeolite Association (http://www.iza-online.org/), some of the preferred zeolite structures (followed in parentheses by their industry names) are those of MFI (ZSM-5), MEL (ZSM-11), MTW (ZSM-12), and MTN (ZSM-39). Zeolites having topologies that are substantially the same as the topologies of these four zeolites are preferred for use in this invention. By “substantially the same” is meant that at least a majority of the crystal structure is identical, and that the pore arrangement and size is approximately equal (i.e., within about 20%).

The topology of a given zeolite is conventionally identified by the X-ray diffraction pattern of the zeolite, and X-ray diffraction patterns of the zeolites given above are known and available in the literature for comparison. For example, the X-ray diffraction patterns and methods of preparation of some of these zeolites are found in the patent literature as follows:

MFI (ZSM-5): U.S. Pat. No. 3,702,886, Robert J. Argauer et al., Nov. 14, 1972

MEL (ZSM-11): U.S. Pat. No. 3,709,979, Pochen Chu, Jan. 9, 1973

MTW (ZSM-12): U.S. Pat. No. 3,832,449, Edward J. Rosinski et al., Aug. 27, 1974.

The disclosures of each of these patents are incorporated herein by reference.

Phosphate-containing molecular sieves include aluminophosphates (commonly referred to in the industry as “AlPO₄” or “AlPO4”), silicoaluminophosphates (commonly referred to as “SAPO”), metal-containing aluminophosphates (commonly referred to as “MeAPO” where the atomic symbol for the metal is substituted for “Me”), and metal-containing silicoaluminophosphates (commonly referred to as “MeAPSO”). Aluminophosphates are formed from AlO₄ and PO₄ tetrahedra and have intracrystalline pore volumes and pore diameters comparable to those of zeolites and silica molecular sieves. Similarly to the zeolites, phosphate-containing molecular sieves that are suitable for use in this invention are those that contain pore-filling members in the openings throughout the crystalline structure, and the same “structure-directing agents” that serve this function in zeolites do so in phosphate-containing molecular sieves. Examples of known phosphate-containing molecular sieves that are commercially available (from UOP LLC, Des Plaines, Ill., USA) and useful in the practice of this invention are those sold under the following names: AlPO4-5; AlPO4-8; AlPO4-11; AlPO4-20; AlPO4-31; AlPO4-41; SAPO-5; SAPO-11; SAPO-20; SAPO-34; SAPO-337; SAPO-35; SAPO-5; SAPO-40; SAPO-42; CoAPO-50.

The compositions, physical characteristics, properties, and methods of preparation of phosphate-containing molecular sieves are known to those skilled in the art and disclosed in readily available literature. The following United States patents, each of which is incorporated herein by reference, are examples of these disclosures: Wilson, S. T., et al., U.S. Pat. No. 4,310,440 (Union Carbide Corporation), issued Jan. 12, 1982 Lok, B. M., et al., U.S. Pat. No. 4,440,871 (Union Carbide Corporation), issued Apr. 3, 1984 Patton, R. L., et al., U.S. Pat. No. 4,473,663 (Union Carbide Corporation), issued Sep. 25, 1984 Messina, C. A., et al., U.S. Pat. No. 4,554,143 (Union Carbide Corporation), issued Nov. 19, 1985 Wilson S. T., et al., U.S. Pat. No. 4,456,029 (Union Carbide Corporation), issued Jan. 28, 1986 Wilson, S. T., et al., U.S. Pat. No. 4,663,139 (Union Carbide Corporation), issued May 5, 1987.

It can be appreciated that high silica-zeolite (HSZ) coatings for aluminum alloys, stainless steels and carbon steels have shown excellent corrosion resistant properties. In addition, high silica-zeolite coatings have strong adhesion to the substrates and extraordinary thermal and mechanical properties. Accordingly, it can be appreciated that these properties, in addition the non-toxicity of zeolites, make zeolite coatings a drop-in environmentally friendly alternative for chromate coatings. However, zeolite coatings are normally synthesized on the substrates in water (hydrothermal synthesis) or other traditional organic solvents (solvothermal synthesis) in sealed reactors. The current hydrothermal deposition process for HSZ-MFI coating is considered inconvenient by the surface finishing industry because it involves the autogenously pressure (i.e. about 9 atm at 175° C. for HSZ-MFI coating synthesis). Accordingly, it would be desirable to have a coating or coating material, wherein the chromate conversion coating can be deposited at ambient pressure, such as about one atmospheric pressure.

In accordance with an exemplary embodiment, a method for synthesizing zeolite films or membranes that uses ionic liquids instead of water as solvent, or called ionothermal synthesis. It can be appreciated that an ionic liquid is a substance that preferably consists only of ions and has a melting temperature below 100° C. In accordance with an embodiment, the ionic liquid or ionic liquid solvents are preferably a salt that is in fluid state at near ambient temperatures (i.e., less than approximately 100° C. and consist of predominantly ionic species. However, it can be appreciated that in accordance with an alternative embodiment, the ionic liquid or ionic liquid solvent can be any salt that melts below the temperature used in the synthesis of zeolites, such as about 100-230° C., preferably about 150° C. to 200° C.

In accordance with an embodiment, one of the most significant advantages of synthesizing zeolite films or membranes using ionic liquids instead of water as solvent is that the whole process can be carried out in an open vessel rather than in a sealed autoclave or other suitable container, that is, at ambient pressure due to the negligible vapor pressure of ionic liquid even at elevated temperature. In accordance with another exemplary embodiment, microwave heating can also be applied to this method of synthesizing zeolite films or membranes to accelerate the synthesis process owing to the rapid microwave absorption of ionic liquids. This method synthesizing zeolite films or membranes can also successfully produce extremely well-oriented zeolite coatings, which can provide excellent corrosion resistant barriers for metal alloys, especially when sealed with a silane/nanocrystal zeolite composite. It can be appreciated that ionothermal synthesis can also be used for zeolite powders, in a convection oven or with microwave radiation. In accordance with another embodiment, it would be desirable to prepare highly oriented zeolite coatings and apply them as corrosion resistant coatings for aluminum alloys or for other applications such as separation at ambient pressure. Once zeolite film or membrane has been synthesized, it can be used at various harsh conditions, such as acid, caustic, high temperature up to 1000° C., high pressure, and etc.

In accordance with an exemplary embodiment, a method for producing zeolite films or membranes at ambient pressure includes the steps of preparing a synthesis mixture comprising an ionic liquid solvent and aluminum and/or silicon and phosphate sources, and convert the synthesis mixture to form a continuous zeolite layer. The method is preferably performed in an open vessel at ambient pressure. In accordance with an embodiment, the ionic liquid solvent is a salt and consists of predominantly ionic species. In another embodiment, the method can be performed in a closed vessel or container, the pressure of the whole system can still be maintained at ambient pressure even at 175° C. when water is in less than 10 wt % in an ionic liquid. In certain instances, microwave heating is applied in the method.

In another embodiment, the method provides i) heating the synthesis mixture to a predetermined temperature and ii) stirring the synthesis mixture at the predetermined temperature for a predetermined amount of time prior to converting the synthesis mixture into a continuous zeolite layer. The synthesis mixture is preferably heated to a temperature of approximately 100° C. and stirred for at least 30 minutes. In accordance with an embodiment, the synthesizing of the synthesis mixture is performed by heating the synthesis mixture to an elevated temperature and holding the synthesis mixture at the elevated temperature until a continuous zeolite layer is formed. The synthesis mixture can be heated to any temperature between 40 to 230° C. Exemplary temperatures include, but are not limited to, 40, 50, 60, 70, 80, 90, 100, 110, 120, 130, 140, 150, 160, 170, 180, 190, 200, 210, 220, and 230° C. Preferably, the synthesis mixture is heated to approximately 150° C. and holding the synthesis mixture at 150° C. for at least 30 minutes until a continuous zeolite layer is formed. In certain instances, the synthesis mixture can be stirred for approximately 4 hours (approximately 240 minutes) at 100° C. For example, the stirring requires at least 10 min at a temperature less than 100° C. In other instances, the synthesis mixture and the substrate can be heated to approximately 150° C. to form a continuous zeolite layer. In yet other instances, the synthesis mixture and the substrate can be heated for several hours to several days at a temperature from about 100 to 230° C. to form a continuous zeolite layer. Microwave heating can also be applied to this method of synthesizing zeolite films or membranes to accelerate the synthesis process. Surprisingly, the synthesis time can be drastically shortened by microwave heating. For example, in the presence of microwave heating the synthesis time is from about 5 min to several hours, such as 2, 3, 4 or 5 hours. It can be appreciated that the step of heating the synthesis mixture can be performed by a convection oven, microwave heating or other suitable heating method.

In accordance with an exemplary embodiment, the synthesis mixture has a molar concentration (or a molar ratio) of the ionic liquid solvent to the aluminum or phosphate source has a predetermined ratio. In one embodiment, the synthesis mixture has a molar concentration (or a molar ratio) of the ionic liquid solvent to the aluminum or phosphate source of at least 1:1, preferably 10:1, and more preferably at least 32:1. A fluorine source, and/or organic template can be added to the synthesis mixture to promote synthesis of the continuous zeolite layer.

In accordance with an embodiment, a substrate can be introduced into the synthesis mixture. The synthesis mixture forms a zeolite coating, which coats the substrate and acts as a corrosion resistant barrier for the substrate. In accordance with an embodiment, the substrate can be pretreated with an Alconox® detergent or other suitable detergent solution. In addition, a sealing agent can be added to the zeolite coating on the substrate. Alternatively, the heating of the synthesis mixture can be performed in a convection oven or with microwave radiation to produce a zeolite powder, which can be applied or sprayed as a corrosion resistant coating.

In accordance with an exemplary embodiment, a method for producing zeolite films or membranes at ambient pressure includes the steps of preparing a synthesis mixture comprising an ionic liquid solvent, and aluminum and/or silicon and phosphate sources, stirring the synthesis mixture for approximately 4 hours (approximately 240 minutes) at 100° C., introducing a substrate, heating the synthesis mixture and the substrate to approximately 150° C., and forming a continuous zeolite layer. In one embodiment, the aluminum or phosphate source can be aluminum propoxide or phosphoric acid, respectively. In accordance with an exemplary embodiment, the synthesis mixture has a predetermined molar composition. In one embodiment, the synthesis mixture has a molar composition of 32[1-methyl-3-ethylimidazolium bromide ([emim]Br)]:1[Al(OC₃H₇)₃]:3[H₃PO₄]:0.8[HF]. Alternatively, the silicon source can be tetraethyl orthosilicate (TEOS) having a molar composition of 0.25Si:1AI. In another embodiment, the phosphorus and aluminum can have a ratio from about 0 to 5. In one embodiment, fluorine and aluminum can have a ratio from about 0 to 5. In another embodiment, silicon and aluminum can have a ratio from about 0 to 5.

In accordance with an embodiment, a substrate can be introduced into an open vessel at ambient temperature. In accordance with an embodiment, the substrate can be fixed vertically inside the synthesis mixture within the open vessel. The vessel is then quickly heated to 150° C. and held at 150° C. for approximately 2 hours (i.e., approximately 120 minutes) under microwave radiation. After heating, the substrate is washed with deionized water and acetone, and dried with compressed air. It can be appreciated that in accordance with an embodiment, the synthesizing process can be repeated one or more times with a fresh synthesis mixture of either the aluminum source or silicon source (e.g. tetraethyl orthosilicate (TEOS) or both to heal the defects of the as-synthesized zeolite coating if there is any.

In accordance with another embodiment, a synthesis mixture composed of silicon and aluminum source, an organic template in water or organic solvents is heated at ambient pressure at temperature from approximately 40° C. to approximately 100° C., such as 40, 50, 60, 70, 80 90 or 100° C. (referred as the first-stage synthesis) and followed by a hydrothermal heating in autogeneous pressure from approximately 100° C. to approximately 160° C. (referred as the second-stage synthesis). In accordance with an exemplary embodiment, to further decrease the nanocrystal size without the trade-of of the nanocrystal yield, an evaporation process can be added before the second stage synthesis. It can be appreciated that the evaporation-assisted two-stage synthesis method is not limited only to MEL structure zeolites, but can be used for other high silica or pure silica zeolites, including but not limited to MFI and BEA structures.

In accordance with a further embodiment, a method of synthesizing zeolite nanocrystals includes preparing a synthesis mixture, and converting the synthesis mixture to form zeolite nanocrystals. The synthesis mixture is stirred for at least 30 minutes, and more preferably for 24 hours at room temperature. In accordance with an exemplary embodiment, the synthesis mixture is comprised of 9.15 g (grams) of tetrabutylammonium hydroxide (TBAOH, 40% aqueous solution), 4.67 g (grams) of double deionized (DDI) water and 10 g (grams) of TEOS. The synthesis mixture is then stirred in a sealed vessel or plastic bottle for one day at room temperature to form a clear homogeneous solution with a molar composition of 0.3TBAOH:1SiO₂:4EtOH:10H₂O. Various components, such as TBAOH, Si, EtOh and H₂O can have a predetermined molar composition. In one embodiment, the molar ratio of TBAOH and Si can be 0.05-1. In another embodiment, the molar ratio of Si:H₂O can be 1:5˜1:20. In yet another embodiment, the molar ratio of Si and EtOH can be 1:1˜20. The vessel is then heated at 80° C. for 2 days with constant stirring in an oil bath. In accordance with an embodiment, about 10-80%, such as 60 wt % of the solvent is evaporated out by house vacuum at room temperature. The synthesis mixture is then transferred to a fluorine-containing polymer (fluoropolymers)-lined autoclave or other suitable autoclave, and heated in a convection oven preheated at 100 to 150° C. for about 2 hrs to produce zeolite nanocrystals having an average crystal size of about 20 to 100 nm, such as 20, 30, 40, 50 or 60 nm (nanometer). In one embodiment, the mixture can be heated at 114° C. for 24 hrs.

In accordance with another exemplary embodiment, a method of synthesizing silane-zeolite nanocrystals for a corrosion resistant coating includes preparing a solution having a silane source and adding a MEL suspension to the solution to form a nanoparticle-silane mixture. The nanoparticle-silane mixture is preferably then spin- or dip-coated on a bare substrate or a SAPO-11 coated sample. The coated sample is then heated to at least 80° C. for at least 2 hours and then at approximately 200° C. for 5 min (minutes), and more preferably heated to at least 80° C. for at least 8 hours (i.e., overnight) and then at approximately 200° C. for 30 min (minutes). In certain instances, the sample was heated at approximately 120° C. to 200° C. In other instances, the sample can be kept at room temperature for several hours.

Exemplary silane source is described in U.S. Pat. No. 7,399,715, which is incorporated herein by reference. In one embodiment, the silence source includes methyltrimethoxysilane, methyltriethoxysilane, methyltri-n-propoxysilane, methyltriisopropoxysilane, methyltri-n-butoxysilane, methyltri-sec-butoxysilane, methyltri-t-butoxysilane, methyltriphenoxysilane, ethyltrimethoxysilane, ethyltriethoxysilane, ethyltri-n-propoxysilane, ethyltriisopropoxysilane, ethyltri-n-butoxysilane, ethyltri-sec-butoxysilane, ethyltri-t-butoxysilane, ethyltriphenoxysilane, n-propyltrimethoxysilane, n-propyltriethoxysilane, n-propyltri-n-propoxysilane, n-propyltriisopropoxysilane, n-propyltri-n-butoxysilane, n-propyltri-sec-butoxysilane, n-propyltri-t-butoxysilane, n-propyltriphenoxysilane, isopropyltrimethoxysilane, isopropyltriethoxysilane, isopropyltri-n-propoxysilane, isopropyltriisopropoxysilane, isopropyltri-n-butoxysilane, isopropyltri-sec-butoxysilane, isopropyltri-t-butoxysilane, isopropyltriphenoxysilane, n-butyltrimethoxysilane, n-butyltriethoxysilane, n-butyltri-n-propoxysilane, n-butyltriisopropoxysilane, n-butyltri-n-butoxysilane, n-butyltri-sec-butoxysilane, n-butyltri-t-butoxysilane, n-butyltriphenoxysilane, sec-butyltrimethoxysilane, sec-butyliso-triethoxysilane, sec-butyltri-n-propoxysilane, sec-butyltriisopropoxysilane, sec-butyltri-n-butoxysilane, sec-butyltri-sec-butoxysilane, sec-butyltri-t-butoxysilane, sec-butyltriphenoxysilane, t-butyltrimethoxysilane, t-butyltriethoxysilane, t-butyltri-n-propoxysilane, t-butyltriisopropoxysilane, t-butyltri-n-butoxysilane, t-butyltri-sec-butoxysilane, t-butyltri-t-butoxysilane, t-butyltriphenoxysilane, phenyltrimethoxysilane, phenyltriethoxysilane, phenyltri-n-propoxysilane, phenyltriisopropoxysilane, phenyltri-n-butoxysilane, phenyltri-sec-butoxysilane, phenyltri-t-butoxysilane, and phenyltriphenoxysilane. These compounds may be used either individually or in combination of two or more.

In another embodiment, the silane source includes tetramethoxysilane, tetraethoxysilane, tetra-n-propoxysilane, tetra-iso-propoxysilane, tetra-n-butoxysilane, tetra-sec-butoxysilane, tetra-t-butoxysilane, tetraphenoxysilane, and the like. These compounds may be used either individually or in combination of two or more.

In yet another embodiment, the silane source includes dimethyldimethoxysilane, dimethyldiethoxysilane, dimethyldi-n-propoxysilane, dimethyldiisopropoxysilane, dimethyldi-n-butoxysilane, dimethyldi-sec-butoxysilane, dimethyldi-t-butoxysilane, dimethyldiphenoxysilane, diethyldimethoxysilane, diethyldiethoxysilane, diethyldi-n-propoxysilane, diethyldiisopropoxysilane, diethyldi-n-butoxysilane, diethyldi-sec-butoxysilane, diethyldi-t-butoxysilane, diethyldiphenoxysilane, di-n-propyldimethoxysilane, di-n-propyldiethoxysilane, di-n-propyldi-n-propoxysilane, di-n-propyldiisopropoxysilane, di-n-propyldi-n-butoxysilane, di-n-propyldi-sec-butoxysilane, di-n-propyldi-t-butoxysilane, di-n-propyldi-phenoxysilane, diisopropyldimethoxysilane, diisopropyldiethoxysilane, diisopropyldi-n-propoxysilane, diisopropyldiisopropoxysilane, diisopropyldi-n-butoxysilane, diisopropyldi-sec-butoxysilane, diisopropyldi-t-butoxysilane, diisopropyldiphenoxysilane, di-n-butyldimethoxysilane, di-n-butyldiethoxysilane, di-n-butyldi-n-propoxysilane, di-n-butyldiisopropoxysilane, di-n-butyldi-n-butoxysilane, di-n-butyldi-sec-butoxysilane, di-n-butyldi-t-butoxysilane, di-n-butyldiphenoxysilane, di-sec-butyldimethoxysilane, di-sec-butyldiethoxysilane, di-sec-butyldi-n-propoxysilane, di-sec-butyldiisopropoxysilane, di-sec-butyldi-n-butoxysilane, di-sec-butyldi-sec-butoxysilane, di-sec-butyldi-t-butoxysilane, di-sec-butyldi-phenoxysilane, di-t-butyldimethoxysilane, di-t-butyldiethoxysilane, di-t-butyldi-n-propoxysilane, di-t-butyldiisopropoxysilane, di-t-butyldi-n-butoxysilane, di-t-butyldi-sec-butoxysilane, di-t-butyldi-t-butoxysilane, di-t-butyldi-phenoxysilane, diphenyldimethoxysilane, diphenyldiethoxysilane, diphenyldi-n-propoxysilane, diphenyldiisopropoxysilane, diphenyldi-n-butoxysilane, diphenyldi-sec-butoxysilane, diphenyldi-t-butoxysilane, and diphenyldiphenoxysilane. These compounds may be used either individually or in combination of two or more.

In still another embodiment, the silane source includes hexamethoxydisilane, hexaethoxydisilane, hexaphenoxydisilane, 1,1,1,2,2-pentamethoxy-2-methyldisilane, 1,1,1,2,2-pentaethoxy-2-methyldisilane, 1,1,1,2,2-pentaphenoxy-2-methyldisilane, 1,1,1,2,2-pentamethoxy-2-ethyldisilane, 1,1,1,2,2-pentaethoxy-2-ethyldisilane, 1,1,1,2,2-pentaphenoxy-2-ethyldisilane, 1,1,1,2,2-pentamethoxy-2-phenyldisilane, 1,1,1,2,2-pentaethoxy-2-phenyldisilane, 1,1,1,2,2-pentaphenoxy-2-phenyldisilane, 1,1,2,2-tetramethoxy-1,2-dimethyldisilane, 1,1,2,2-tetraethoxy-1,2-dimethyldisilane, 1,1,2,2-tetraphenoxy-1,2-dimethyldisilane, 1,1,2,2-tetramethoxy-1,2-diethyldisilane, 1,1,2,2-tetraethoxy-1,2-diethyldisilane, 1,1,2,2-tetraphenoxy-1,2-diethyldisilane, 1, 1,2,2-tetramethoxy-1,2-diphenyldisilane, 1,1,2,2-tetraethoxy-1,2-diphenyldisilane, 1,1,2,2-tetraphenoxy-1,2-diphenyldisilane, 1,1,2-trimethoxy-1,2,2-trimethyldisilane, 1,1,2-triethoxy-1,2,2-trimethyldisilane, 1,1,2-triphenoxy-1,2,2-trimethyldisilane, 1,1,2-trimethoxy-1,2,2-triethyldisilane, 1,1,2-triethoxy-1,2,2-triethyldisilane, 1,1,2-triphenoxy-1,2,2-triethyldisilane, 1,1,2-trimethoxy-1,2,2-triphenyldisilane, 1,1,2-triethoxy-1,2,2-triphenyldisilane, 1,1,2-triphenoxy-1,2,2-triphenyldisilane, 1,2-dimethoxy-1,1,2,2-tetramethyldisilane, 1,2-diethoxy-1,1,2,2-tetramethyldisilane, 1,2-diphenoxy-1,1,2,2-tetramethyldisilane, 1,2-dimethoxy-1,1,2,2-tetraethyldisilane, 1,2-diethoxy-1,1,2,2-tetraethyldisilane, 1,2-diphenoxy-1,1,2,2-tetraethyldisilane, 1,2-dimethoxy-1,1,2,2-tetraphenyldisilane, 1,2-diethoxy-1,1,2,2-tetraphenyldisilane, 1,2-diphenoxy-1,1,2,2-tetraphenyldisilane, bis(trimethoxysilyl)methane, bis(triethoxysilyl)methane, bis(tri-n-propoxysilyl)methane, bis(tri-1-propoxysilyl)methane, bis(tri-n-butoxysilyl)methane, bis(tri-sec-butoxysilyl)methane, bis(tri-t-butoxysilyl)methane, 1,2-bis(trimethoxysilyl)ethane, 1,2-bis(triethoxysilyl)ethane, 1,2-bis(tri-n-propoxysilyl)ethane, 1,2-bis(tri-1-propoxysilyl)ethane, 1,2-bis(tri-n-butoxysilyl)ethane, 1,2-bis(tri-sec-butoxysilyl)ethane, 1,2-bis(tri-t-butoxysilyl)ethane, 1-(dimethoxymethylsilyl)-1-(trimethoxysilyl)methane, 1-(diethoxymethylsilyl)-1-(triethoxysilyl)methane, 1-(di-n-propoxymethylsilyl)-1-(tri-n-propoxysilyl)methane, 1-(di-1-propoxymethylsilyl)-1-(tri-1-propoxysilyl)methane, 1-(di-n-butoxymethylsilyl)-1-(tri-n-butoxysilyl)methane, 1-(di-sec-butoxymethylsilyl)-1-(tri-sec-butoxysilyl)methane, 1-(di-t-butoxymethylsilyl)-1-(tri-t-butoxysilyl)methane, 1-(dimethoxymethylsilyl)-2-(trimethoxysilyl)ethane, 1-(diethoxymethylsilyl)-2-(triethoxysilyl)ethane, 1-(di-n-propoxymethylsilyl)-2-(tri-n-propoxysilyl)ethane, 1-(di-1-propoxymethylsilyl)-2-(tri-1-propoxysilyl)ethane, 1-(di-n-butoxymethylsilyl)-2-(tri-n-butoxysilyl)ethane, 1-(di-sec-butoxymethylsilyl)-2-(tri-sec-butoxysilyl)ethane, 1-(di-t-butoxymethylsilyl)-2-(tri-t-butoxysilyl)ethane, bis(dimethoxymethylsilyl)methane, bis(diethoxymethylsilyl)methane, bis(di-n-propoxymethylsilyl)methane, bis(di-1-propoxymethylsilyl)methane, bis(di-n-butoxymethylsilyl)methane, bis(di-sec-butoxymethylsilyl)methane, bis(di-t-butoxymethylsilyl)methane, 1,2-bis(dimethoxymethylsilyl)ethane, 1,2-bis(diethoxymethylsilyl)ethane, 1,2-bis(di-n-propoxymethylsilyl)ethane, 1,2-bis(di-1-propoxymethylsilyl)ethane, 1,2-bis(di-n-butoxymethylsilyl)ethane, 1,2-bis(di-sec-butoxymethylsilyl)ethane, 1,2-bis(di-t-butoxymethylsilyl)ethane, 1,2-bis(trimethoxysilyl)benzene, 1,2-bis(triethoxysilyl)benzene, 1,2-bis(tri-n-propoxysilyl)benzene, 1,2-bis(tri-1-propoxysilyl)benzene, 1,2-bis(tri-n-butoxysilyl)benzene, 1,2-bis(tri-sec-butoxysilyl)benzene, 1,2-bis(tri-t-butoxysilyl)benzene, 1,3-bis(trimethoxysilyl)benzene, 1,3-bis(triethoxysilyl)benzene, 1,3-bis(tri-n-propoxysilyl)benzene, 1,3-bis(tri-1-propoxysilyl)benzene, 1,3-bis(tri-n-butoxysilyl)benzene, 1,3-bis(tri-sec-butoxysilyl)benzene, 1,3-bis(tri-t-butoxysilyl)benzene, 1,4-bis(trimethoxysilyl)benzene, 1,4-bis(triethoxysilyl)benzene, 1,4-bis(tri-n-propoxysilyl)benzene, 1,4-bis(tri-1-propoxysilyl)benzene, 1,4-bis(tri-n-butoxysilyl)benzene, 1,4-bis(tri-sec-butoxysilyl)benzene, 1,4-bis(tri-t-butoxysilyl)benzene, and the like. These compounds may be used either individually or in combination of two or more.

It can be appreciated that in accordance with an embodiment, the solution is a mixture of 1,2-bis(triethoxysilyl)methane (BTSM) deionized water and ethanol having a volume ratio of BTSM to deionized water to Ethanol of approximately 1:1:20. Alternatively, the ratio of EtOH and BTSM can be from about 0 to 40. The ratio of deionized water and BTSM can be from about 0 to 40. An acid, such as acetic acid can be added to adjust the pH of the solution in the range of about 3 to 7, preferably 4.5 to 5. The solution is then preferably stirred at room temperature for at least 24 hours before adding the MEL suspension having a concentration in the solution of approximately 5 to 200 ppm (parts per million). In one embodiment, the concentration is 20 ppm. Alternatively, the MEL suspension can be added first, then adjust the pH.

It can be appreciated that the silicon, aluminum, fluorine, phosphate and ionic liquid sources as disclosed herein are merely examples of materials that can be used with the methods and processes as disclosed herein and that other silicon, aluminum, fluorine, phosphate and ionic liquid sources can be used without departing from the present invention. For example, in accordance with an embodiment, the silicon source can be an aqueous sodium silicate, a colloidal silica sol, a fumed silica, Tetramethyl- and tetraethylorthosilicate (TMeOS and TEOS), a precipitated silica, sodium metasilicate, a silica gel, ammonium hexafluorosilicate or other suitable silicon material or source. In addition, the aluminum source can be selected from sodium aluminate, aluminum (Al), pseudo-boemite, Gibbsite, or aluminum isopropoxide. In accordance with an embodiment, the phosphorus source can be aluminum phosphate or phosphoric acid.

In accordance with an exemplary embodiment, a fluorine (F) source can be added to ionic liquid solvent to help control the product of the reaction between the ionic liquid solvent and the aluminum or phosphorous source, including controlling the yield of the crystalline product and its crystallinity. The fluorine source can be an aqueous hydrofluoric acid, ammonium fluoride, sodium fluoride, hydrogen fluoride pyridine, and/or tetraethylammonium fluoride.

In accordance with another exemplary embodiment, the ionic liquid or ionic liquid solvent (or source) can include one or more anions: Cl—, Br—, I—, [BF4]-, [AlC14]-, [Al2Cl7]-, [Al2Br7]-, [PF6]-, [NO3]-, [NO2]-, [CH3CO2]-, [SO4]2-, [CF3SO3]-, [CF3CO2]-, [N(SO2CF3)2]-, [N(CN)2]-, [CB11H6C16]-, [CH3CB11H11]-, [C2H5CB11H11]- and one or more cations: substituted tetraalkylammonium ions, substituted pyridinium ions, and/or substituted Imidazolium ions, such as 1-Methyl-3-methylimidazolium, 1-Ethyl-3-methylimidazolium, 1-Propyl-3-methylimidazolium, 1-Isopropyl-3-methylimidazolium, 1-Butyl-3-methylimidazolium, 1-Pentyl-3-methylimidazolium, 1,1′-Dimethyl-3,3′-hexamethylene diimidazolium and 1-methoxyethyl-3-methylimidazolium. The alkyl groups as described herein preferably have 20 or few main chain carbon atoms. The substituents for the pyridinum and imidazolium ions can be alkyl, halogen, alkoxy, —CN, aryl, alkoxycarbonyl, carboxy, acyloxy and the like.

### Example 1

### AEL Coating Synthesis on Aluminum Alloys.

In accordance with an exemplary embodiment, both AIOPO-11 and SAPO-11 were synthesized on Al alloys. These alumino- and silicoalumino-phosphate zeolites have an AEL-type framework. A synthesis mixture with molar composition: 32[1-methyl-3-ethylimidazolium bromide ([emim]Br)]:1[Al(OC₃H₇)3]:3[H₃PO₄]:0.8[HF] was pre hours (approximately 240 minutes) at 100° C. For SAPO-11, tetraethyl orthosilicate (TEOS) was introduced to synthesis mixture with the molar ratio of 0.25Si:1AI. Metal substrates (i.e., AA 2024-T3 substrates) were pretreated by an Alconox detergent solution. The substrates were then fixed vertically inside the synthesis mixture in the Teflon vessel designed for MARS5 (CEM Co.) microwave reaction system. The unsealed vessel (with holes on the cover) was then quickly heated to 150° C. and held at the temperature for 2 hours (approximately 120 minutes) under microwave radiation. After the synthesis, the coated sample was thoroughly washed with DI water and acetone and dried with compressed air. For SAPO-11 samples, the synthesis procedure was repeated at least once or twice more with fresh synthesis solution.

### Synthesis of Zeolite Nanocrystals

Evaporated-Assisted Two-Stage Synthesis Method for Zeolite Nano-Crystals

In accordance with another exemplary embodiment, pure-silica-zeolites (PSZs) can be used as an additive to corrosion resistant coatings, which have advantages of uniform micro-porosity, high thermal conductivity, superior mechanical strength and high hydrophobicity. For example, it would be desirable to develop new methods and processes for preparing PSZ MFI zeolite and PSZ MEL zeolite nano-crystals with high yield. With a traditional one-stage hydrothermal method, higher nanocrystal yield is normally achieved by increasing synthesis time or temperature, and typically accompanied with larger crystal size, which can introduce problems, such as uneven distribution of particles, increased surface roughness and large mesopores. It can be appreciated that in accordance with an exemplary embodiment, a two-stage method was employed to replace the traditional one-stage method to obtain smaller crystal size and higher crystallinity.

In accordance with an embodiment, a synthesis protocol or method of preparing MEL nanocrystals (i.e., evaporation-assisted two-stage method) includes an evaporation process between two thermal-treatment stages, and which produces smaller nanoparticles while holding the nanocrystal yield high. It can be appreciated that in accordance with an embodiment, the mechanism of nanocrystal growth can be explored by investigating the nanoparticle size distribution, wherein, for example, in an exemplary embodiment, bi-modal distribution was observed, and the primary 14 nm nanocrystals preserved in the final suspension with a yield of 62%.

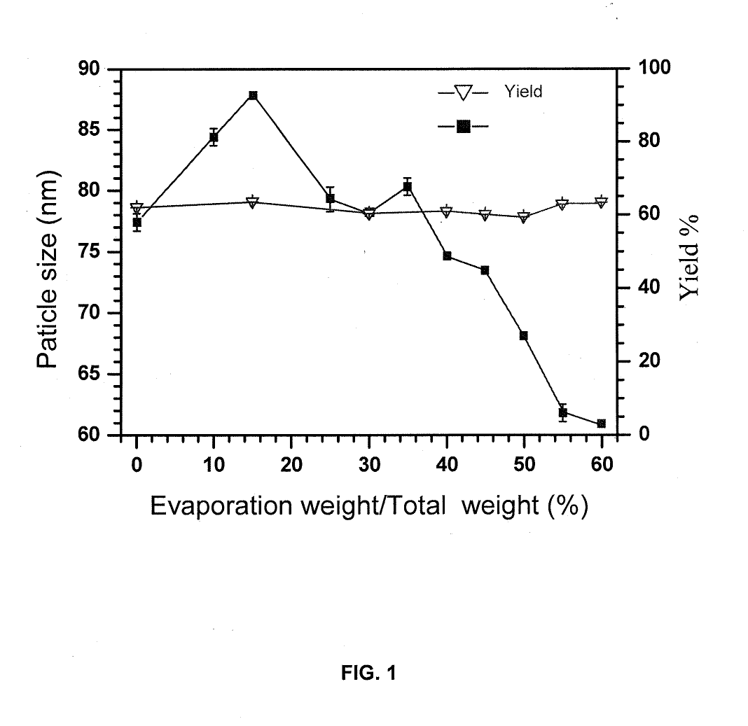

It can be appreciated that in accordance with an exemplary embodiment, the nanocrystal size and yield of the nanoparticle suspension are important. FIG. 1 shows the intensity-weighted mean particle size, analyzed by dynamic light scattering (DLS) measurement, and the nanocrystal yield of different samples against the evaporation amount in accordance with an exemplary embodiment. As shown in FIG. 1, with the evaporation-assisted two-stage synthesis method, the nanocrystal size decreases with evaporation amount when the evaporated water is greater than 20% of the total weight. In addition, the nanocrystal yield remains the same for different samples. In accordance with an exemplary embodiment, the mean particle size initially increases with a small amount of solvent evaporation, from 77 nm (E-0) to 88 nm (E-15). Here E-xx (i.e., 0, 15, 30, 35, 40, and 50) is used to stand for the sample prepared with xx wt % solution evaporated out (e.g., E-15 means 15 wt % was evaporated). When the solvent evaporation is higher than 15 wt %, the mean size decreases sharply, from 88 nm (E-15) to 61 nm (E-60). For MEL E-60, the mean particle size is 61 nm, which is much smaller than E-0 (77 nm). In addition, it was found that the yield of MEL nanocrystals is held around approximately 61% regardless of how much solvent is evaporated.

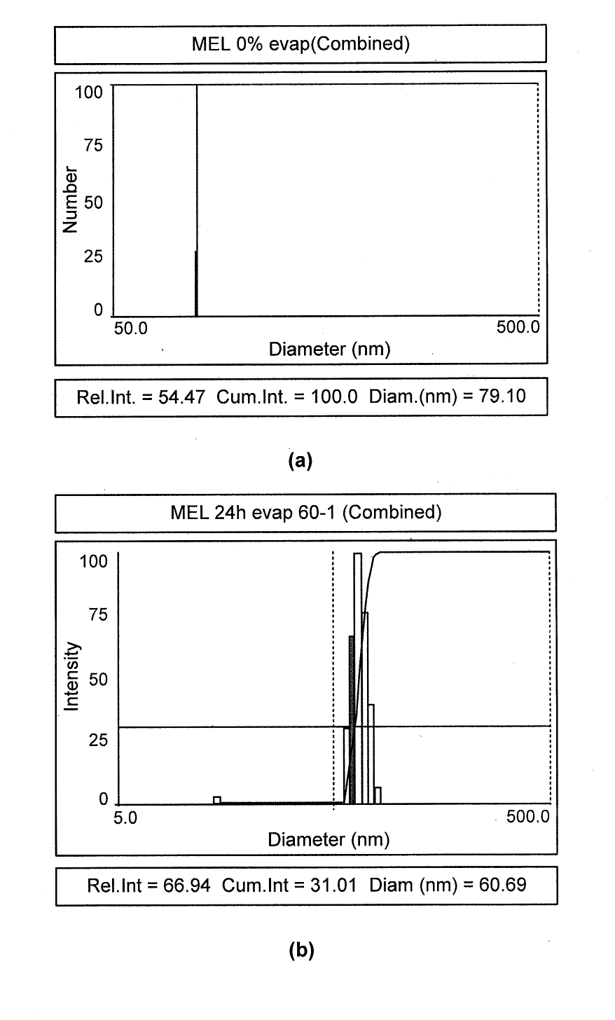

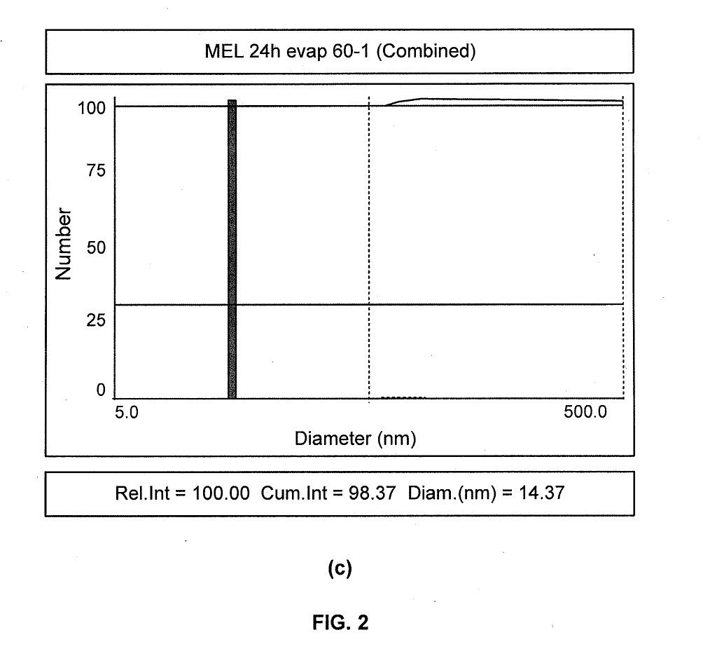

In order to understand the nanocrystal growth mechanism during synthesis, the nanoparticle size distributions of as-synthesized suspensions were analyzed by dynamic light scattering (FIG. 2). The particle diameter (green solid column in the plot), the relative integration and cumulative integration are shown below the plot. Relative integration is the population of the particle size over the highest population, and the cumulative integration is the cumulative population up to the particle diameter. When the evaporation amount is less than 40 wt %, MEL nanoparticle suspensions have a mono-modal distribution both in intensity-weighted distribution and number-weighted distribution (FIG. 2(a)). Once the evaporation amount is greater than 40 wt %, the nanoparticle size has a bi-modal distribution. The bi-modal distribution is shown in two formats: intensity-weighted and number-weighted profiles. FIG. 2(b) is the intensity-weighted distribution of E-60. Since the intensity-weighted distribution gives higher weight to larger particles, the major component in this distribution has a size around 70 nm. By contrast, the number-weighted distribution provides the same weight to different sizes as shown in FIG. 2(c). The majority (98.4%) of the nanoparticles have a size around 14 nm, and a small amount of particles exist at about 70 nm, which is close to the mean particle size of MEL E-0 (i.e., 79 nm).

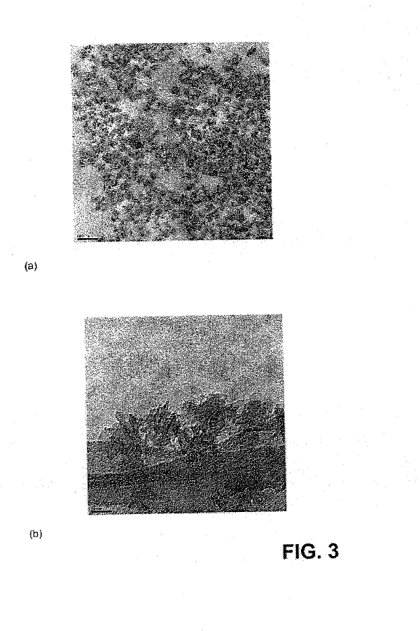

The particle size and distribution from dynamic light scattering (DLS) analysis was also confirmed by TEM images, as shown in FIG. 3. In FIG. 3(a) with a scale bar of 100 nm, most crystals are smaller than 20 nm, while a few agglomerates are around 70 nm. The zoom-in image (FIG. 3(b) with a scale bar of 20 nm) shows that the nanocrystals do not have a regular shape, and the lattices with different orientations are indicative of the crystalline structure of these small particles.

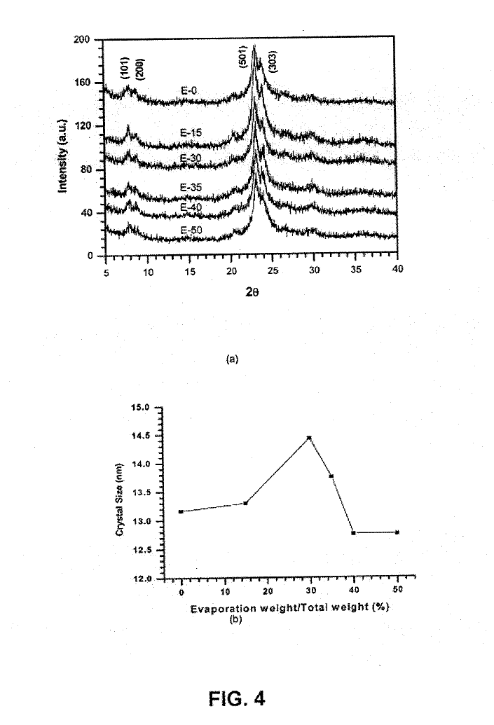

X-ray diffraction (XRD) was also employed to characterize the crystalline structure of MEL nanoparticle powder. The XRD patterns indicate that the crystallinity remains the same when different amounts of water are evaporated. In FIG. 4(a), the XRD patterns verify that the nanocrystals from different batches all have the MEL structure, regardless of the amount of evaporated solution. The Scherrer formula is used here to estimate the mean primary nanocrystal size from XRD patterns:

$$L = \frac{K {λ}_{α 1}}{( {β}_{m} - {β}_{o} ) cos θ}$$

where L is the particle size of the sample, K is the constant parameter (usually K=0.9), λ_{α1} is equal to 1.54060 Å for Cu K_{α1}, βₘ is the measured full width at half height of the peak positioned at 2θ and β₀ is the broadening peak due to the XRD machine itself. As shown in FIG. 4(b), all the mean primary nanocrystal sizes are as small as approximately 12.8 to 14.5 nm. The particle size first increases and then decreases with evaporation amount.

It can be appreciated that calculated mean primary nanocrystal sizes from the XRD patterns are in agreement with the particle sizes analyzed by DLS and observed in TEM. In accordance with an exemplary embodiment, in the as-synthesized MEL suspension, the primary nanocrystals are small (e.g., 14 nm) and there are different degrees of agglomeration in different batches. For E-0 suspension, all of the primary particles (about 13.1 nm) agglomerate into secondary particles (about 77 nm). For E-60 suspension, most primary particles do not agglomerate and are preserved in the final synthesized suspension, although there are still less than approximately 2% of agglomerated large particles. The agglomerates have a size around 70 nm, which is slightly smaller than the secondary particle sizes in E-0 suspension due to E-60's smaller primary particle sizes. The primary particle size first increases and then decreases with evaporation amount. It can be appreciated that by making a number of changes, including differences in concentration, pH value and viscosity during the second-stage synthesis the results can vary as shown.

For example, in accordance with an exemplary embodiment, during the evaporation process, the concentrations of silica species, structure-directing agent (SDA) and hydroxyl groups increase. In accordance with an exemplary embodiment, a crystallization mechanism of PSZ with TEOS as the silica precursor, the nucleation process starts with core (silica)-shell (SDA) amorphous nanoparticles (fresh nanoparticles), and then goes through a series of intermediate phases (mature nanoparticles) that gradually become closer and closer to zeolite-like structures. The process eventually ends up with the perfect zeolite structure (nuclei). Throughout this process, while their shape and size remain the same, the nanoparticles are subjected to structure and chemical composition adjustments via adsorption of surrounding SDA. The crystal growth is proposed to be the oriented aggregation of nuclei and attachment of mature nanoparticles to growing crystals.

In accordance with an exemplary embodiment, an evaporation process between the two synthesis stages can be implemented to increases the concentration of the species in the suspension, which facilitates the crystal growth. On the other hand, more nuclei can also be formed due to the evaporation-induced super-saturation. These two processes compete for the mature nanoparticles in the solution. Thus, the increase of crystal growth rate can also increase the mean particle size in the as-synthesized suspension, while the increase of nucleation rate will decrease the mean particle size. As shown in FIG. 4, the change in particle size reveals that the aggregation process of mature nanoparticles that grow into crystals dominates when evaporation is small and the transformation into nuclei prevails when the evaporation amount is large. When the evaporation is greater than 30%, the primary crystal size starts to decrease, which is indicative of the slower crystal-growth speed. This process is accompanied by an increase in nucleation rate after the evaporation process. In other words, when the evaporation amount is small, the mature nanoparticles tend to attach to growing crystals during the second-stage synthesis, and when the evaporation amount is large, the mature nanoparticles are likely to transform into nuclei (nucleation reaction) instead.

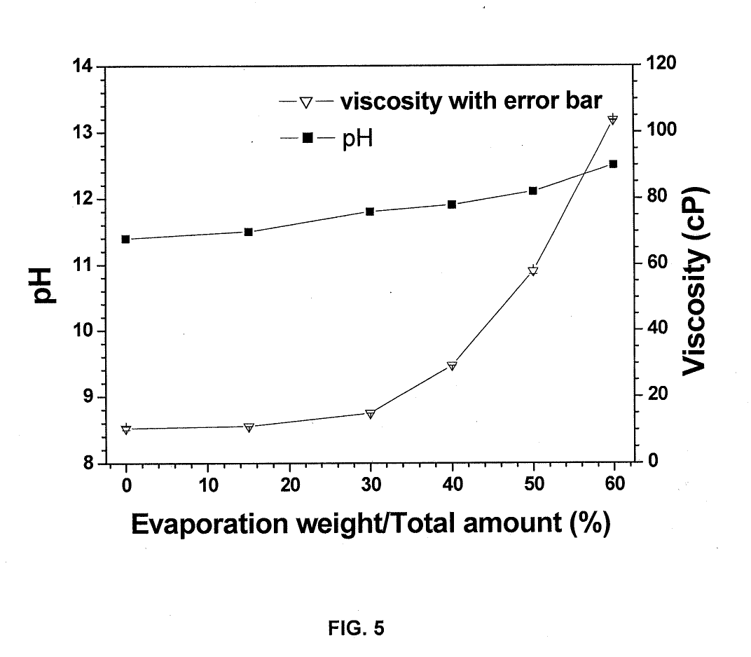

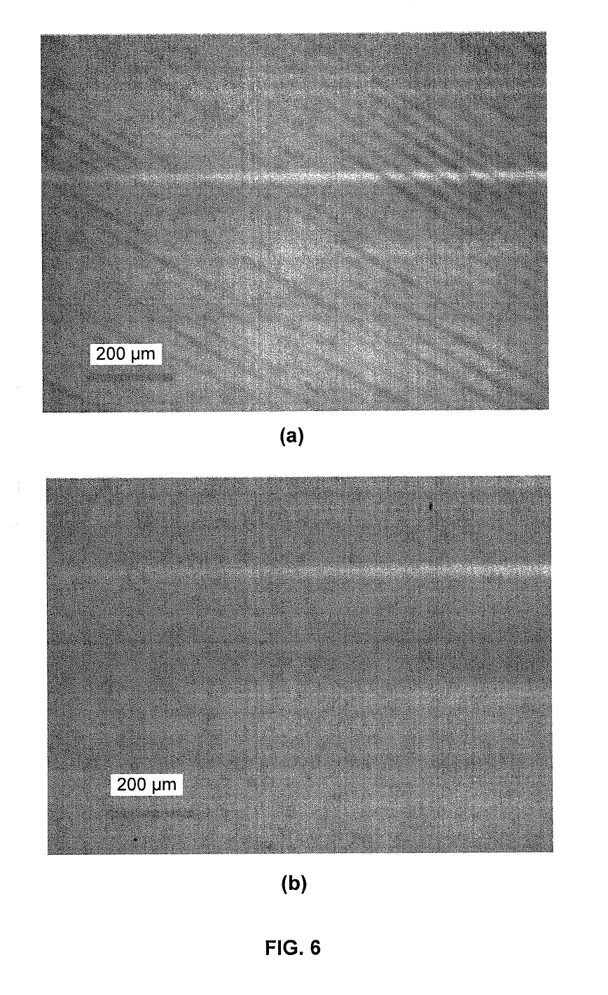

Another factor that reduces the nanocrystal size is the change of pH value in the solution. FIG. 5 shows that the pH values of the solution at the second-stage of the synthesis with different amount of evaporation increase from 11.4 to 12.5. The pH value affects both the repulsive force among nanoparticles and reaction for crystal growth in the solution. It can be appreciated that zeta potential in a tetraalkylammonium silicate solution system with TEOS as the silica precursor can produce particles, which are negative-charged, and thus, the repulsive forces between nanoparticles are very strong. Moreover, the repulsive force can increase with pH value. In addition, it can be appreciated that usually the nanocrystals around 14 nm are not stable in the suspension because of the high surface energies, and instead, they tend to agglomerate into larger particles; hence, the mean primary crystal size of E-0 sample is only 13 nm while the average particle size in the suspension measured by dynamic light scattering (DLS) is 77 nm. For MEL E-60, the increase in pH value makes the repulsive force between nanoparticles so high that it is difficult for the particles to get closer to each other, and therefore, the particles are stable in the suspension. The mean primary nanocrystal size estimated by XRD is consistent with the measured values by DLS and TEM. Bringing the results together, it is clear that most primary crystals of 14 nm are preserved in the as-synthesized suspension and only a small amount of agglomerated particles (less than 2%) have a size of 70 nm.

Furthermore, it is difficult for crystals to grow in higher pH suspension. The reaction formula for the silicon-oxygen-silicon connectivity is described as

R—Si—O⁻+R′—Si—OH [symbol] R—SiO—Si—R′+OH⁻

At higher pH values, the reaction for crystal growth is not preferred. It can be appreciated that in accordance with an exemplary embodiment and according to the results as shown in FIGS. 4(a) and 4(b), the pH factor can play a role when the evaporation amount is greater than 30 wt %.

In accordance with another exemplary embodiment, the increase in the suspension viscosity (FIG. 5) can also be responsible for the decrease in particle size. In suspensions with higher viscosities, the movement of particles and all the species can be restricted and the resistance of both oriented aggregation for crystal growth and agglomeration into secondary particles can be much higher.

In accordance with an exemplary embodiment, the decrease of particle size is the combined result of the change of concentration, pH value and viscosity in the solution. It can be appreciated that when the amount of solvent evaporation is small, crystal growth dominates, and when the amount of solvent evaporation is large (greater than 15%), nucleation prevails. In accordance with another embodiment, higher nucleation can reduce the particle size. The increase in pH value results in the higher negative charge on the particle surface, which in turn makes the repulsive force stronger so that the nanoparticles are more stable. Accordingly, at higher pH values, crystal growth is not preferred. In accordance with another embodiment, increasing the solution viscosity increases the resistance of agglomeration and crystal growth.

In accordance with an exemplary embodiment, the system or method for producing nanocrystals includes an evaporation-assisted two-stage synthesis method to prepare MEL nanoparticle suspension. In accordance with an exemplary embodiment, the particle size decreases with increasing amount of solvent evaporation while the nanocrystal yield stays the same. During the evaporation process, the ethanol in the synthesis solution is removed so that the pressure during the second stage is lower. When the evaporation of the solvent is greater than 40 wt % of the total weight, bi-modal particle distribution is observed. Furthermore, most of the primary nanocrystals (around 14 nm) were successfully preserved in the final suspension. It can be appreciated that the mechanism of the nanocrystal growth during the synthesis is comprised of at least three factors (concentration, pH value and viscosity), which in preferred embodiments reduce the size of the nanocrystals.

### Example 2

MEL PSZ nanocrystal suspension was synthesized in the following way: 9.15 g of tetrabutylammonium hydroxide (TBAOH, 40% aqueous solution, Sachem) and 4.67 g of double deionized (DDI) water were added into 10 g of tetraethylorthosilicate (TEOS, 98%, Aldrich). The mixture was stirred in a sealed plastic bottle for 24 hr at room temperature, and finally a clear homogeneous solution was formed with the molar composition of 0.3TBAOH:1SiO2:4EtOH:10H2O. The solution was then thermally treated at 80° C. for 2 days with constant stirring in an oil bath (noted as the first stage). Afterwards, a specific amount (varying from 10 wt % to 60 wt %) of solvent was evaporated out by house vacuum at room temperature with stirring. This solution was subsequently transferred to Teflon®-lined autoclaves and kept in a convection oven preheated at 114° C. for 24 hr (noted as the second stage). This synthesis approach is hereby referred to as an evaporation-assisted two-stage synthesis method. For convenience, in this application, E-xx is used to stand for the sample prepared via the evaporation-assisted two-stage synthesis method with xx wt % solvent evaporated out (e.g. E-15 means 15 wt % was evaporated). If there is no evaporation process, it is called the two-stage synthesis method and the resulting MEL suspension is noted as E-0.

To quantify the yield of the nanoparticle suspension, the following protocol was devised. The as-synthesized MEL suspension was diluted 1:5 (in volume) in double deionized (DDI) water and subject to centrifugation at 20,000 rpm (45,700 g) for 1 hr. The separated nanocrystals and supernatant were dried in an 80° C. oven overnight and calcined at 400° C. for 2 hr to remove the organic structure-directing agent (SDA). The calcined crystal and leftover were weighed (noted as W_{c} and Wₐ, respectively). The yield of the nanocrystals was defined as W_{c}/(W_{c}+Wₐ)×100%.

Particle size and distribution were measured by dispersing 0.05 mL of as-synthesized suspension in 4 mL of DDI water and analyzed by dynamic light scattering (DLS) with Zeta Potential Analyzer (ZetaPALS, Brookhaven). The mean particle size was the intensity-weighted average. Both the intensity-weighted distribution and the number-weighted distribution of as-synthesized suspension were monitored.

Particle size and crystallinity were observed with both transmission electron microscopy (TEM, Philips Tecnai12) with an accelerating voltage of 120 kV and powder X-ray diffraction (XRD) (Bruker D8 Advanced Diffractometer) with Cu Kα radiation.

### Example 3

### Silane-Zeolite Nanocrystal Coatings

In accordance with another exemplary embodiment, a 1,2-bis(triethoxysilyl)methane (BTSM) solution was prepared by adding silane to a DI water and ethanol mixture. The volume ratio of BTSM: DI water: Ethanol was approximately 1:1:20. Acetic acid was then added to adjust the pH of the solution in the range of approximately 4.5 to 5. The solution was then stirred at room temperature for aging at least 24 hours before a MEL suspension was added. MEL concentration in the solution was about 20 ppm (parts per million). Then the nanoparticle-silane mixture was spun on bare AI alloys or SAPO-11 coated AI Alloys at room temperature on a Laurell spin coater. Afterward, the sample was heated at 80° C. overnight and then 200° C. for 30 min (minutes).

### Characterization

In accordance with another exemplary embodiment, the XRD patterns were obtained on Siemens D-500 diffractometer using Cu Kα radiation. SEM pictures were obtained on a Philips

XL30-FEG scanning electron microscope. Samples were etched for cross-sectional SEM imaging by dipping the samples in 0.5 wt % HF for several seconds. A VCA-Optima XE was used for the contact-angle measurement. DC polarization testing was carried out with Solartron potentiostat SI 1287 in a three-electrode Flat Cell (Princeton Applied Research Model K0235) with a Pt counter electrode and a saturated calomel electrode (SCE) as the reference electrode. The corrosive medium was 0.1 mol/L (moles per litre) NaCl aqueous solution. The samples were immersed in the corrosive medium for approximately 30 min (minutes) prior to the DC polarization test with a sweep rate of 1 mV/s.

### Evaluation of AEL Corrosion-Resistant Zeolite Coatings

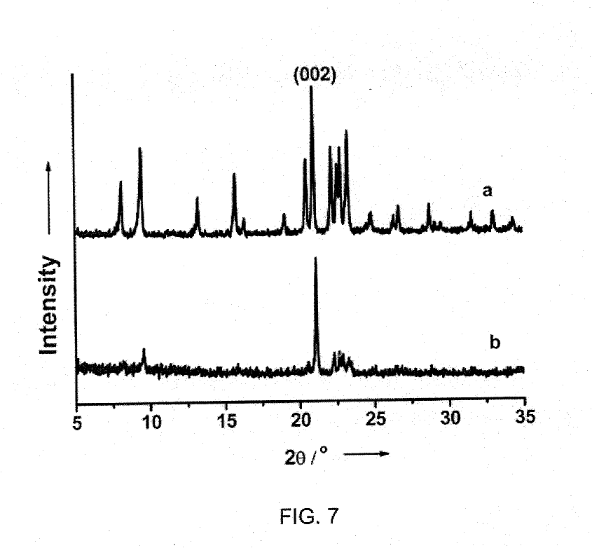

The presence and identity of the AEL coatings, both AIPO-11 and SAPO-11, on AA 2024-T3 were confirmed by the X-ray diffraction (FIG. 7). FIG. 7 shows XRD patterns of AEL coatings on a substrate (i.e., AA 2024-T3) for AIPO-11 and SAPO-11, respectively. No other by-products were found. In accordance with an embodiment, a preferred orientation is evident for the SAPO-11 coatings. AEL consists of a 10-membered-ring channel (0.40×0.65 nm) parallel to the c-axis of the crystal. The strong (002) reflection peak in the SAPO-11 XRD pattern indicates that the one-dimensional channels are perpendicular to the AI alloy surface. Alternatively, as shown in FIG. 7, the XRD pattern of AIPO-11 coating for this sample produced a more random orientation.

Scanning electron microscope (SEM) images (FIG. 8) show that both AIPO-11 and SAPO-11 crystals have a typical hexagonal rod-like morphology. FIGS. 8(a)-8(f) show SEM images of different as-synthesized AEL coatings on a substrate (i.e., AA 2024-T3) for AIPO-11 (surface) (FIG. 8(a); AIPO-11 (cross section) (FIG. 8(b)); SAPO-11 (surface, inset is higher magnification with a scale bar of 2 μm) (FIG. 8(c)); SAPO-11 (cross section, mildly polished surface) (FIG. 8(d)); SAPO-11 with spin-on BTSM-MEL (surface) (FIG. 8(e)); and SAPO-11 with spin-on BTSM-MEL (cross section) (FIG. 8(f)). For AlPO-11, crystal bundles are deposited on the substrate randomly with crystal intergrowth. In contrast, SAPO-11 crystals with an average hexagon diameter of 1.5 μm are packed densely, with their c-axis perpendicular to the substrate surface, which is consistent with the XRD result. Moreover, from the cross-sectional SEM picture (FIG. 8(d)), the intergrowth between the oriented crystals is well-developed near the surface of the substrate, which demonstrates that the SAPO-11 film forms a compact and continuous coating (i.e., layer and/or membrane).

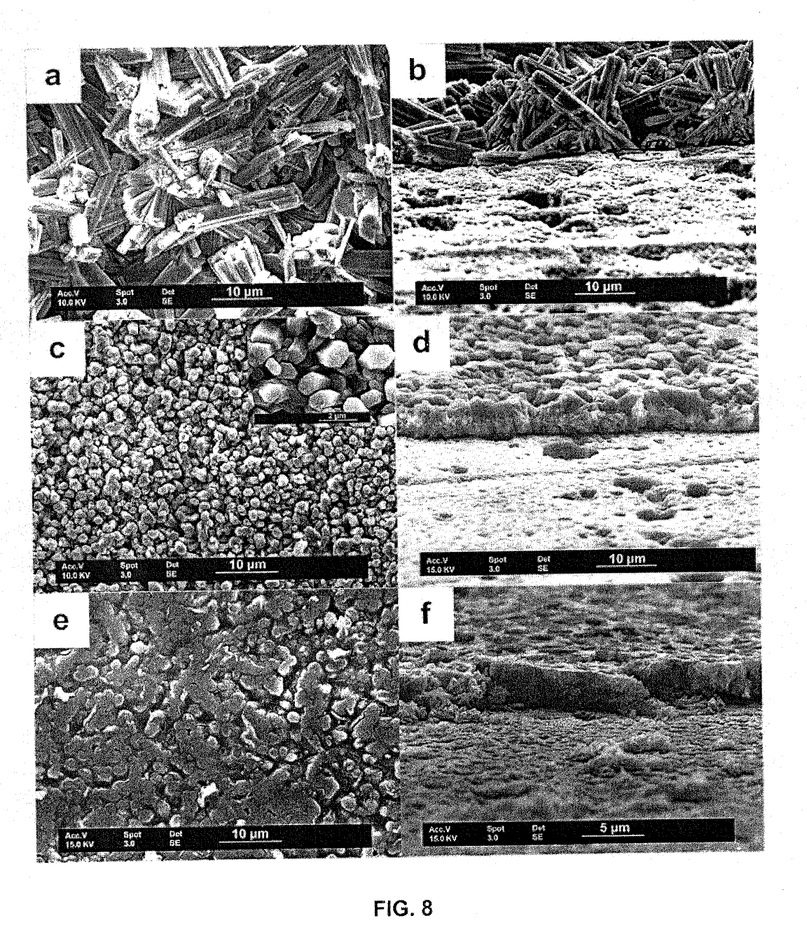

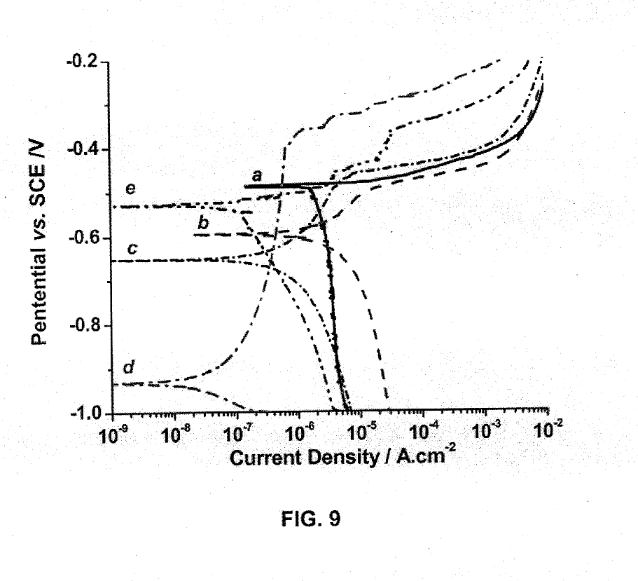

In accordance with another embodiment, corrosion resistance of AEL coating on the substrate (AA 2024-T3) was investigated by DC polarization. FIG. 9 shows that a bare substrate (AA 2024-T3) pits at its open circuit potential (OCP) (ca. −0.5 V_{SCE}). That is, the pitting corrosion occurs once the metal is immersed in the corrosive media. The open circuit potential (OCP) corrosion is related with the intermetallics of Cu in AI matrix and the presence of Cl⁻ in the electrolyte.

In accordance with an exemplary embodiment, both open circuit potentials (OCPs) of SAPO-11 (ca. −0.65 V_{SCE}) and AlPO-11 (ca. −0.6 V_{SCE}) coated samples are more negative than bare AA 2024-T3 substrate, which can indicate that the AEL coatings inhibit the open circuit potential (OCP) corrosion of the samples. The corrosion current density of SAPO-11 and AIPO-11 coated samples is about two and one orders of magnitude smaller than that of the bare AI alloy. In accordance with an embodiment, the SAPO-11 coating showed that the pitting potential is slightly higher than the OCP of AA 2024-T3, which means the favored sites for pit initiation, mostly the copper intermetallics, are at least partially covered by the SAPO-11 coatings.

It can be seen from the cross-sectional SEM picture of SAPO-11 coating (FIG. 8(d)) that the film consists of two major components: the dense barrier layer adjoining the metal and a porous layer extending from the barrier layer to the outer surface of the film, which is similar to the anodized film of AI alloys. This kind of structure has the advantage of being able to be dyed. However, it can be appreciated that in accordance with an embodiment, in order to obtain the maximum corrosion resistance, the porous coating should be sealed. A nano-zeolite filled silane was used as the sealing agent. Several aspects were considered in choosing silane as the sealing agent: (1) silane has very good adhesion properties, which can act as a binder layer between zeolite coating and the polymer top coat; (2) silane film itself has good corrosion resistant for AI alloys; (3) nano-particle filled silane films offer better mechanical properties and MEL nanocrystal filled silane films also improve the corrosion resistance (FIG. 9); (4) silane film can improve the surface hydrophobicity, which benefits the corrosion resistance. In accordance with an embodiment, a dilute BTSM solution mixed with 20 ppm MEL nanocrystals was spun on the mildly polished SAPO-11 coating. The SEM pictures show the polished SAPO-11 coating before (FIG. 8(d)) and after the sealing process (FIGS. 8(e) and (f)). The surface of the modified coating is much more even than before and the pores were sealed by BTSM-MEL. The water contact angle increases from approximately 0 to 20° to approximately 70 to 90° after sealing. It is noted that no cracking or peeling-off of the as-synthesized SAPO-11 film was observed during polishing, indicating that the film has excellent mechanical strength and adhesion.

FIGS. 9(a)-9(e) show DC polarization curves for bare and coated substrates (i.e., AA 2024-T3) in 0.1 mol/L NaCl at room temperature: Bare substrate—AA 2024-T3 (FIG. 9(a)): AlPO-11 coated substrate (FIG. 9(b)); SAPO-11 coated substrate (FIG. 9(c)); SAPO-11 with spin-on BTSM-MEL coated (FIG. 9(d)); and spin-on BTSM-MEL coated (FIG. 9(e)). As shown in FIG. 9, the DC polarization results show that the BTSM-MEL modified SAPO-11 coating has very good corrosion resistance. The OCP is negative than −0.9 V and the corrosion current is less than 10-⁸ mA/cm². The pitting potential also increases to −0.4 V, even higher than the pure AI at similar conditions. The DC polarization behavior of BTSM-MEL spin-on coating directly on bare AA 2024-T3 was also tested (FIG. 9) and showed good corrosion resistance. However, as shown in FIG. 9, the combination of SAPO-11 coating and BTSM-MEL sealing provided the best anticorrosion performance.

It will be understood that the foregoing description is of the preferred embodiments, and is, therefore, merely representative of the article and methods of manufacturing the same. It can be appreciated that many variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims. In addition, each reference provided herein is incorporated by reference in its entirety to the same extent as if each reference was individually incorporated by reference.

What is claimed is:

1. A method for producing zeolite films or membranes at essentially ambient pressure, comprising:
preparing a synthesis mixture comprising an ionic liquid solvent and an aluminum and/or a silicon and/or a phosphate source; and
converting the synthesis mixture to form a continuous zeolite layer.

2. The method of claim 1, further comprising prior to converting the synthesis mixture:
heating the synthesis mixture; and
stirring the synthesis mixture.

3. The method of claim 2, wherein the synthesis mixture is heated to about 100° C. and stirred for at least 30 minutes.

4. The method of claim 1, wherein the step of converting the synthesis mixture comprises heating the synthesis mixture and holding the synthesis mixture at an elevated temperature until the continuous zeolite layer is formed.

5. The method of claim 4, wherein the step of converting the synthesis mixture comprises heating the synthesis mixture to approximately 150° C. and holding the synthesis mixture at 150° C. for at least 30 minutes until the continuous zeolite layer is formed.

6. The method of claim 4, wherein the step of converting comprises heating with microwave radiation.

7. The method of claim 4, wherein the step of heating the synthesis mixture to approximately 150° C. and holding the synthesis mixture at 150° C. for at least 30 minutes until the continuous zeolite layer is formed is performed by microwave heating.

8. The method of claim 1, wherein the ionic liquid solvent, the aluminum and phosphate source have a predetermined ratio.

9. The method of claim 8, wherein a molar concentration (or a molar ratio) of the ionic liquid solvent to the aluminum or phosphate source is at least 10:1.

10. The method of claim 1, further comprising:
introducing a substrate to the synthesis mixture: and
coating the substrate with a zeolite coating, which acts as a corrosion resistant barrier for the substrate.

11. The method of claim 10, further comprising adding a sealing agent to the zeolite coating on the substrate.

12. The method of claim 1, further comprising adding a fluorine source to the synthesis mixture, wherein the fluorine source promotes synthesis of the continuous zeolite layer.

13. The method of claim 1, wherein the ionic liquid solvent is a salt and consists of predominantly ionic species.

14. The method of claim 1, wherein the method is performed in an open vessel at ambient pressure.

15. The method of claim 1, wherein the method is performed in a closed vessel at ambient pressure.

16. The method of claim 1, further comprising:
heating the synthesis mixture in a convection oven or with microwave radiation to produce a zeolite powder; and
adding the zeolite powder to a coating to increase the corrosion resistance of the coating.

17. The method of claim 16, wherein the coating is a silane and/or a commercialized paint.

18. A method for producing zeolite films or membranes at ambient pressure, comprising:
providing an ionic liquid solvent;
introducing an aluminum and/or a silicon and/or a phosphate source to form a synthesis mixture;
stirring the synthesis mixture at an elevated temperature;
heating the synthesis mixture under conditions sufficient to a continuous zeolite layer.

19. The method of claim 18, wherein the synthesis mixture is stirred for about 4 hours at 100° C. and heated to about 150° C.

20. The method of claim 18, wherein the synthesis mixture has a predetermined molar composition.

21. The method of claim 18, wherein the synthesis mixture has a predetermined molar composition of ionic liquid solvent to the aluminum source.

22. The method of claim 21, wherein the synthesis mixture has a molar composition of ionic liquid solvent to the aluminum source of at least 10:1.

23. The method of claim 20, wherein the aluminum source is aluminum and the synthesis mixture has a molar composition of 32[1-methyl-3-ethylimidazolium bromide([emim]Br)]:1[Al(OC₃H₇)₃]:3[H₃PO₄]:0.8[HF].

24. The method of claim 18, wherein the silicon source and Al source have a predetermined molar ratio.

25. The method of claim 24, wherein the silicon source is tetraethyl orthosilicate (TEOS) having a molar ratio of 0.25Si:1Al.

26. The method of claim 18, further comprising introducing a substrate to the synthesis mixture and depositing said zeolite layer on the substrate to form a coated substrate.

27. The method of claim 26, further comprising pre-treating the substrate with a detergent solution.

28. The method of claim 26, further comprising fixing the substrate vertically inside the synthesis mixture within an open vessel.

29. The method of claim 28, further comprising quickly heating the vessel to 150° C. and holding the vessel at 150° C. for approximately 2 hours under microwave radiation.

30. The method of claim 26, further comprising:
washing the coated substrate with deionized water, acetone or ethanol; and
drying the coated substrate with compressed air.

31. The method of claim 24, further comprising repeating the synthesis process one or more times with a fresh synthesis mixture.

32. A method of synthesizing zeolite nanocrystals, comprising:
preparing a synthesis mixture, the synthesis mixture having a silica or a silica and alumina source, and a template; and
synthesizing the synthesis mixture to form zeolite nanocrystals.

33. The method of claim 32, further comprising:
heating the synthesis mixture to a temperature of approximately 60° C. to 150° C.; and
stirring the synthesis mixture for at least 12 hours.

34. The method of claim 32, wherein the synthesis mixture is comprised of 9.15 g (grams) of tetrabutylammonium hydroxide (TBAOH, 40% aqueous solution) and 4.67 g (grams) of double deionized (DDI) water are added into 10 g (grams) of TEOS.

35. The method of claim 34, further comprising:
stirring the synthesis mixture under conditions sufficient to form a homogeneous solution with a predetermined molar composition of TBAOH, SiO₂, EtOH and H₂O.

36. The method of claim 35, wherein the synthesis mixture is stirred in a sealed vessel or plastic bottle for at least 12 hours at room temperature to form a clear homogeneous solution with a molar composition of 0.3TBAOH:1SiO₂:4EtOH:10H₂O.

37. The method of claim 35, further comprising heating the vessel at 80° C. for at least 12 hours with constant stirring in an oil bath.

38. The method of claim 35, further comprising evaporating at least 30 wt % of solvent by housing vacuum at room temperature.

39. The method of claim 35, further comprising transferring the synthesis mixture to a fluorine-containing polymer-lined autoclave; and
heating the synthesis mixture in a convection oven preheated to approximately 100 to 150° C. for at least 2 hours to produce zeolite nanocrystals having an average crystal size of about 60 nm (nanometer).

40. A method of synthesizing silane-zeolite nanocrystals for a corrosion resistant coating, comprising:
preparing a solution having a silane source;
adding a MEL suspension to the solution to form a nanoparticle-silane mixture;
spin or dip coating the nanoparticle-silane mixture on a SAPO-11 coated sample or bare substrate; and
heating the sample and then heating the synthesis mixture.

41. The method of claim 42, wherein the step of heating comprises heating the sample at 80° C. for at least 2 hours, and then heating the synthesis mixture at about 200° C. for 5 minutes.

42. The method of claim 40, wherein the solution is a mixture of a silane, deionized water and ethanol.

43. The method of claim 42, wherein the silane is 1,2-bis(triethoxysilyl)methane (BTSM).

44. The method of claim 40, wherein BTSM, deionized water and ethanol have a predetermined volume ratio.

45. The method of claim 44, wherein the volume ratio of BTSM to deionized water to ethanol is approximately 1:1:20.

46. The method of claim 40, further comprising adding acetic acid to adjust the pH of the solution in the range of approximately 3 to 7.

47. The method of claim 46, wherein the pH of the solution is in the range between about 4.5 to 5.

48. The method of claim 44, further comprising stirring the solution at room temperature for at least 24 hours before adding the MEL suspension.

49. The method of claim 46, wherein a concentration of MEL in the solution is approximately 5-200 ppm.

50. A method for producing zeolite films or membranes at essentially ambient pressure, said method comprising:
generating zeolites in an ionic liquid; and
converting said zeolites under conditions sufficient to form a continuous zeolite layer.

51. The method of claim 50, wherein said step of converting comprises crystallizing said zeolites under conditions sufficient to form a continuous zeolite layer.

52. The method of claim 50, wherein said zeolite layer is a crystalline zeolite film or membrane.

53. A method of synthesizing a corrosion resistant zeolite coating, said method comprising:
providing a zeolite nanocrystal layer; and
contacting said zeolite nanocrystal layer with a sealing agent under conditions sufficient to form a corrosion resistant zeolite coating.
